(19) United States
(12) Patent Application Publication
(10) Pub. No.: US 2010/0023584 A1
(43) Pub. Date: Jan. 28, 2010

(54) METHOD AND SYSTEM FOR CREATING A PERSONALIZED SOCIAL NETWORK IN A TELECOMMUNICATION NETWORK

(75) Inventors: Kashyap Kamdar, Palatine, IL (US); Bertrand K. Fondjo, Lake in the Hills, IL (US); Gaurav S. Gupta, Schaumburg, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/178,177

(22) Filed: Jul. 23, 2008

(51) Int. Cl. G06F 15/16

(52) U.S. Cl. 709/206; 709/204

(57) ABSTRACT

The invention describes a method and system for creating a social network in a telecommunication network. The method includes extracting one or more contact information stored in a telecommunication device of a user. The one or more contact information is added to the social network of the user in response to extracting the contact information stored in the telecommunication device of the user. The method also includes organizing the contact information based on a degree of separation between the user and the contact information. The method further includes enabling the user to perform a set of operations by using the telecommunication device in the social network. The set of operations includes posting and searching a review corresponding to an object in the social network.

### FIELD OF THE INVENTION

The present invention generally relates to social networking. More specifically, the present invention relates to creating a social network in a telecommunication network.

### BACKGROUND OF THE INVENTION

With the advent of the internet, the world now has enhanced interconnectivity, and it became possible to connect one or more users to other users. Various internet based communication modes like email and chat-enabled interaction can be used among the one or more users located in different geographies. Over time there have been significant advances in information sharing methods on the internet. Several web based social networking sites have come into existence, for example, http://www.facebook.com and http://www.orkut.com. The web based social networking sites allow a user to create a web based social network with friends and family members. The user accesses the web based social network using a computing device. The user is granted access to the web based social network upon successful authentication. The user may create the web based social network based on a set of interests of the user. The user can add other users to the web based social network based on a common interest shared between the user and the other users. The web based social network may be targeted towards the other users sharing a specific interest. The web based social network can be, for example, an academic network, a professional network and a hobby sharing network. The user adds the other users to the web based social network by sending an invitation using email. The web based social network enables the users sharing similar interests to come together on a common platform to discuss their comments or opinions on various aspects pertaining to a subject of interest.

Another way of sharing information is through blogs, where the user submits comments and opinions on one or more subject matter. The one or more subject matter may include but is not limited to popular gadgets, home made remedies and intellectual property rights. Further, public review posting sites, for example, http://www.yelp.com also enable the user to publish comments and opinions on the subject of interest.

Existence of web based social networks, blogs and public review posting sites has enabled the user to post reviews, recommendations or rankings as well as search reviews, recommendations or rankings published by the other users corresponding to the subject of interest. Therefore, the web based social networks, blogs and public review posting sites help the user in arriving at an opinion on the subject of interest.

Many times a review is posted by an anonymous user or the other user who is unknown to the user. Therefore, establishing authenticity of the review becomes difficult. Further, interest level of the user and the other users who have posted the review on a subject of interest may vary, therefore, the review may not be relevant to the user.

There is therefore a need of a method and a system for creating a social network that enables the users to search and retrieve reviews posted by the other users who can be trusted and are reliable.

### SUMMARY OF THE INVENTION

An object of the invention is to provide a method and system for creating a social network in a telecommunication network that includes one or more trusted members.

Another object of the invention is to provide a method and system for obtaining reliable results when searching for a review in a social network in a telecommunication network.

Yet another object of the invention is to provide a method and system for accessing a social network in a telecommunication network without requiring user authentication.

The above listed and various other objects are achieved by providing a method and a system for creating a social network in a telecommunication network. The method includes extracting one or more contact information stored in a telecommunication device of a user. The method includes adding the one or more contact information to the social network in the telecommunication network of the user. Thereafter, the method organizes the one or more contact information based on a set of predefined parameters. The method further includes enabling the user to perform a set of operations such as posting and searching of reviews corresponding to an object of interest in the social network in the telecommunication network by using the telecommunication device of the user.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram showing an exemplary environment in which various embodiments of the invention can function.

FIG. 2 illustrates a flowchart of a method for creating a social network in a telecommunication network in accordance with an embodiment of the invention.

FIG. 3 illustrates a flowchart of a method for organizing one or more contact information in a social network in a telecommunication network in accordance with an embodiment of the invention.

FIG. 4 illustrates a flowchart of a method for posting a review in a social network in a telecommunication network in accordance with an embodiment of the invention.

FIG. 5 illustrates a flowchart of a method for searching a review in a social network in a telecommunication network in accordance with an embodiment of the invention.

FIG. 6 is a block diagram showing a system for creating a social network in a telecommunication network in accordance with an embodiment of the invention.

FIG. 7 is a block diagram showing a system for organizing one or more contact information in a social network in a telecommunication network in accordance with an embodiment of the invention.

FIG. 8 is a block diagram showing a system for enabling a user to perform a set of operations using a telecommunication device of the user in a social network in a telecommunication network in accordance with an embodiment of the invention.

FIG. 9 is a block diagram showing a system for posting a review in a social network in a telecommunication network in accordance with an embodiment of the invention.

FIG. 10 is a block diagram showing a system for searching a review in a social network in a telecommunication network in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and system components related to method and system for creating a social network in a telecommunication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Generally speaking, pursuant to various embodiments, the present invention provides a method and system for creating a social network in a telecommunication network. The present invention further provides a method and system for enabling a user to perform a set of operations like posting and searching a review corresponding to an object by using a telecommunication device of the user in the social network.

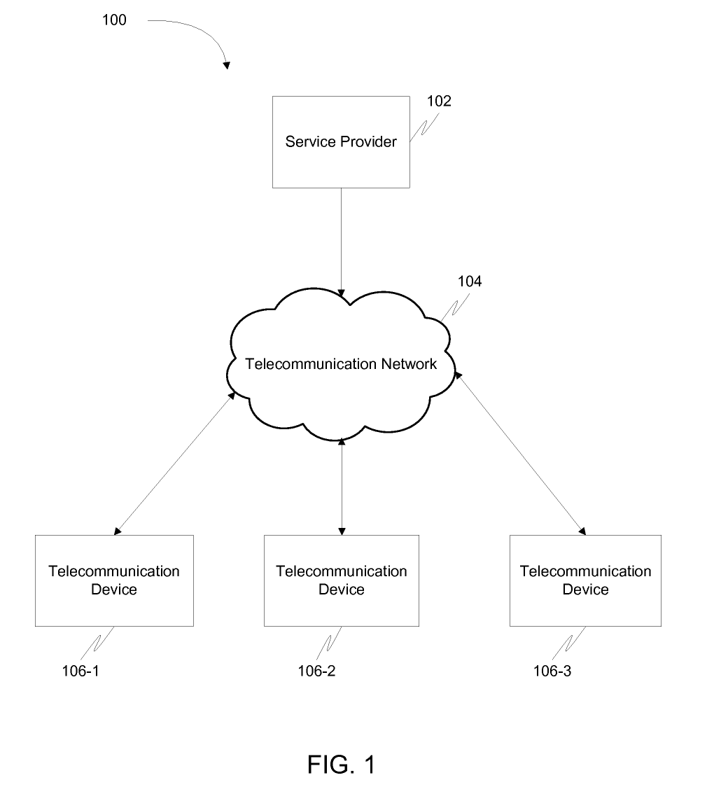

FIG. 1 is a block diagram showing an exemplary environment 100 in which various embodiments of the invention can function. Environment 100 includes a service provider 102, a telecommunication network 104 and one or more telecommunication devices 106-n. The service provider 102 provides one or more services in the telecommunication network 104. The telecommunication devices 106-n access the one or more services provided by the service provider 102 using the telecommunication network 104. As depicted in FIG. 1, the telecommunication devices 106-n include a telecommunication device 106-1, a telecommunication device 106-2 and a telecommunication device 106-3. The telecommunication devices 106-n can be for example, but are not limited to, a mobile phone, a pager and a Personal Digital Assistant (PDA).

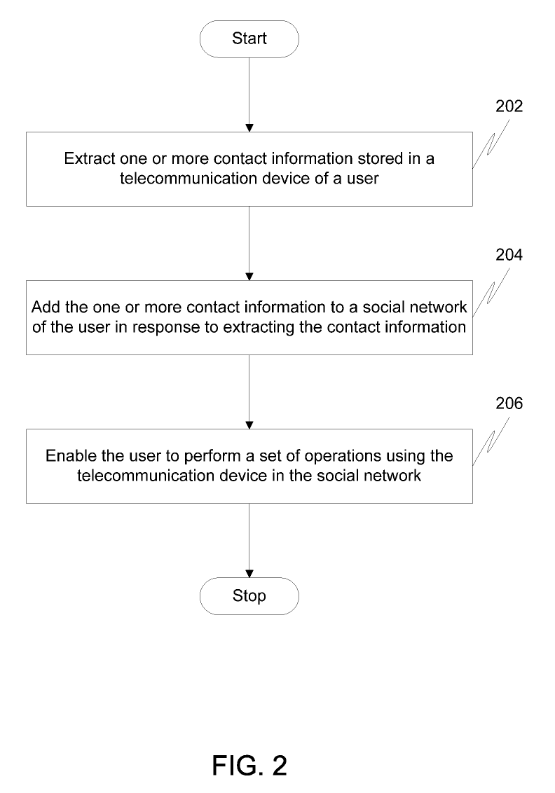

FIG. 2 is a flowchart illustrating a method for creating a social network in a telecommunication network in accordance with an embodiment of the invention. A user of the telecommunication device 106-1 accesses the one or more services provided by the service provider 102. In an embodiment of the invention, the one or more services provided by the service provider 102 may include a social networking service. In another embodiment of the invention a third party service provider may provide the social networking service to the user using the telecommunication network 104. The user of the telecommunication device 106-1 may subscribe to the social networking service provided by the service provider 102. In an embodiment of the invention, the user of the telecommunication device 106-1 may subscribe to the social networking service provided by the third party service provider. Using the social networking service, the user may create a social network corresponding to the user in the telecommunication network 104. In order to create the social network corresponding to the user, one or more contact information stored in the telecommunication device 106-1 of the user is extracted at step 202. The one or more contact information may include but is not limited to a name, a contact number and an email address corresponding to one or more users stored in a phone book of the telecommunication device 106-1 of the user. In an embodiment of the invention, one or more contact information stored in one or more telecommunication communication device belonging to the one or more contact information stored in the telecommunication device 106-1 of the user is extracted and so on.

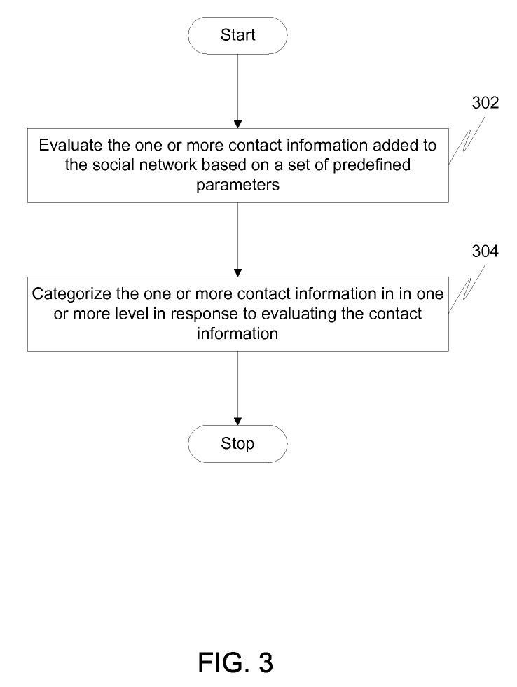

In response to extraction of the one or more contact information, the one or more contact information is added to the social network of the user at step 204. The one or more contact information in the social network may further be updated from other sources including but not limited to internet and an email client corresponding to the user. In an embodiment of the invention, the one or more contact information in the social network of the user is organized. A method of organizing the one or more contact information in the social network of the user has been explained in detail in conjunction with FIG. 3.

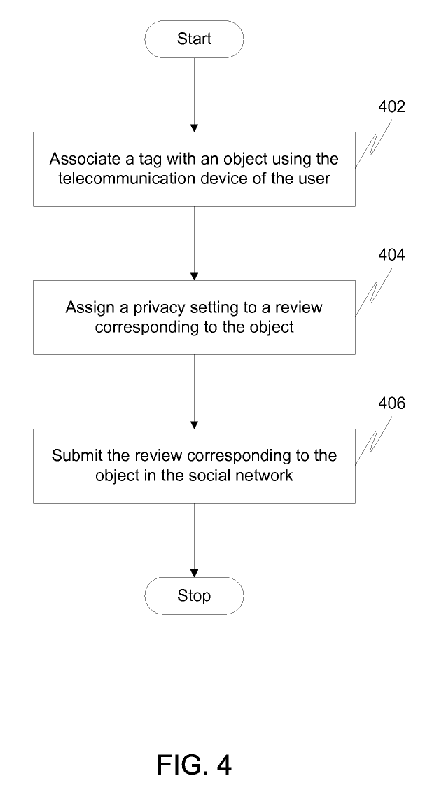

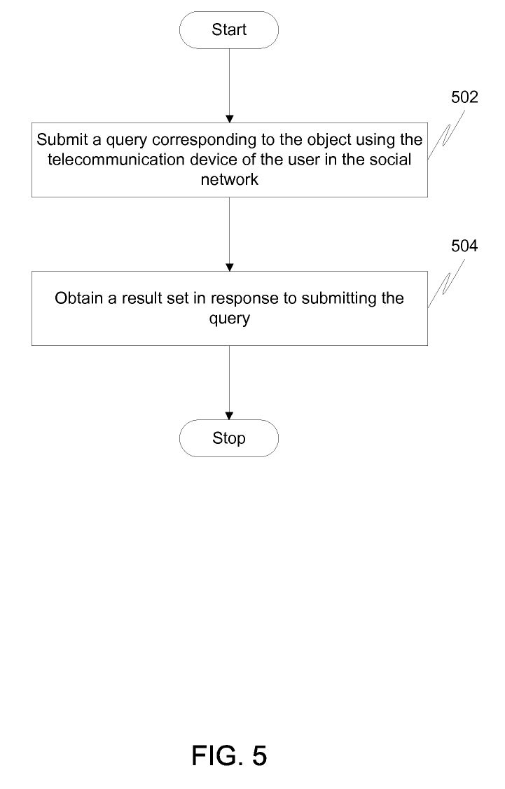

At step 206, the user is enabled to perform a set of operations in the social network using the telecommunication device 106-1 of the user. The set of operations includes for example, but are not limited to, posting a review corresponding to an object, searching a review corresponding to an object, deleting a review corresponding to an object and rating a review corresponding to an object in the social network. Methods of posting a review and searching for a review in the social network have been explained in detail in conjunction with FIG. 4 and FIG. 5 respectively.

FIG. 3 is a flowchart illustrating a method for organizing one or more contact information in a social network in a telecommunication network, in accordance with an embodiment of the invention. The social network of the user includes the one or more contact information corresponding to the one or more users. The one or more contact information is organized for better management of the social network. At step 302, the one or more contact information is evaluated based on a set of predefined parameters. The set of predefined parameters may include for example, but is not limited to, a degree of separation between the user and the one or more users and a predefined preference of the user. The predefined preference of the user may include for example, but is not limited to, grouping the one or more users into one or more groups like friend, colleague, business, married, bachelor and family member. In response to evaluation, the one or more contact information is categorized at step 304 in different levels or in a hierarchy. The one or more contact information in the social network of the user may be categorized into a first level, a second level, a third level and so on. In an exemplary embodiment of the invention, the one or more contact information corresponding to the one or more users stored in the telecommunication device 106-1 of the user is categorized in a first level. The one or more contact information categorized in the first level is further categorized into a friend group and a business group based on a preference of the user. Other contact information corresponding to other users stored in a telecommunication device of a user corresponding to a first level contact information is categorized in a second level. It would be apparent to a person skilled in the art that the contact information can be categorized in a third level, a fourth level and so on, based on the set of predefined parameters.

FIG. 4 is flowchart illustrating a method for posting a review corresponding to an object in a social network in a telecommunication network in accordance with an embodiment of the invention. At step 402, a tag is associated with the review corresponding to the object using the telecommunication device 106-1 of the user. The tag can be for example, but is not limited to, a photo, a video, an audio clip, a text, a user comment, a location information and a barcode corresponding to the object. The tag is obtained by using various features of the telecommunication device 106-1 of the user. The tag can be obtained, for example, from one or more of, but not limited to, a multimedia feature, an RFID detector and a barcode reader of the telecommunication device 106-1. In an exemplary embodiment of the invention, the user can click a photo corresponding to an object using a multimedia camera in the telecommunication device 106-1. Thereafter, the photo can be associated with the review corresponding to the object to be used as a tag for the object.

In an embodiment of the invention, the tag may be one or more information corresponding to the object obtained from a third party source. In an exemplary embodiment of the invention, the user can click a photo corresponding to an object using a multimedia camera in the telecommunication device 106-1 of the user. Also, a price corresponding to the object is obtained from the third party source. Thereafter, the photo and the price can be associated with the review corresponding to the object to be used as a tag for the object.

At step 404, the user assigns a privacy setting to the review corresponding to the object in the social network of the user. The privacy setting may include, for example, but is not limited to, a visibility setting and an accessibility setting corresponding to the review of the object. In an exemplary embodiment of the invention, the user may configure the accessibility setting corresponding to the review of the object posted by the user. As a result of the accessibility setting, the other users corresponding to the other contact information categorized in a second level in the social network of the user cannot view the review corresponding to the object. In another exemplary embodiment of the invention, the user may configure the accessibility setting to the review corresponding to the object such that only a few specified other users can have an access to the review posted by the user in the social network. In yet another exemplary embodiment of the invention, the user may configure a visibility setting to the review corresponding to the object posted by the user. As a result of the visibility setting, other users corresponding to other contact information categorized in a third level in the social network of the user cannot view the user's information.

At step 406, the user submits the review corresponding to the object in the social network by using the telecommunication device 106-1 of the user. In an exemplary embodiment of the invention, the user may use one or more of a Short Message Service (SMS) or a Multimedia Messaging Service (MMS) for submitting the review in the social network. In another exemplary embodiment of the invention, the user may use existing communication means supported by the telecommunication device 106-1 for submitting the review in the social network.

FIG. 5 is a flowchart illustrating a method for searching a review corresponding to an object in a social network in a telecommunication network in accordance with an embodiment of the invention. At step 502, the user submits a query corresponding to the object in the social network using the telecommunication device 106-1 of the user. The user includes a tag corresponding to the object in the query. In an exemplary embodiment of the invention, the user may scan a barcode corresponding to an object using the telecommunication device 106-1 of the user and use the barcode scan as a tag corresponding to the object. The user then includes the barcode scan in a query corresponding to the object using the telecommunication device 106-1 of the user.

In another embodiment of the invention, the tag may be one or more information corresponding to the object obtained from a third party source. In an exemplary embodiment of the invention, the user may scan a barcode corresponding to an object using the telecommunication device 106-1 of the user. The user may also obtain a photo corresponding to the object from the third party source. The user may then use the barcode scan and the photo as a tag and include them in a query corresponding to the object using the telecommunication device 106-1 of the user.

In response to submitting the query, the user obtains one or more results corresponding to the object. The results may include for example, but are not limited to, one or more reviews, one or more recommendations and a ranking corresponding to the object. In an embodiment of the invention, the user obtains one or more information corresponding to the object obtained from a third party source along with the one or more results. In an exemplary embodiment of the invention, the user obtains a list of features obtained from the third party source corresponding to an object along with five reviews corresponding to the object.

In an embodiment of the invention, the one or more results are compiled based on a privacy setting and an accessibility setting associated with the one or more results. Based on the privacy setting and the accessibility setting, a result is obtained and presented to the user. In an exemplary embodiment of the invention a result may be presented to the user as posted by an anonymous user after compilation of the one or more results based on the privacy setting configured by the anonymous user.

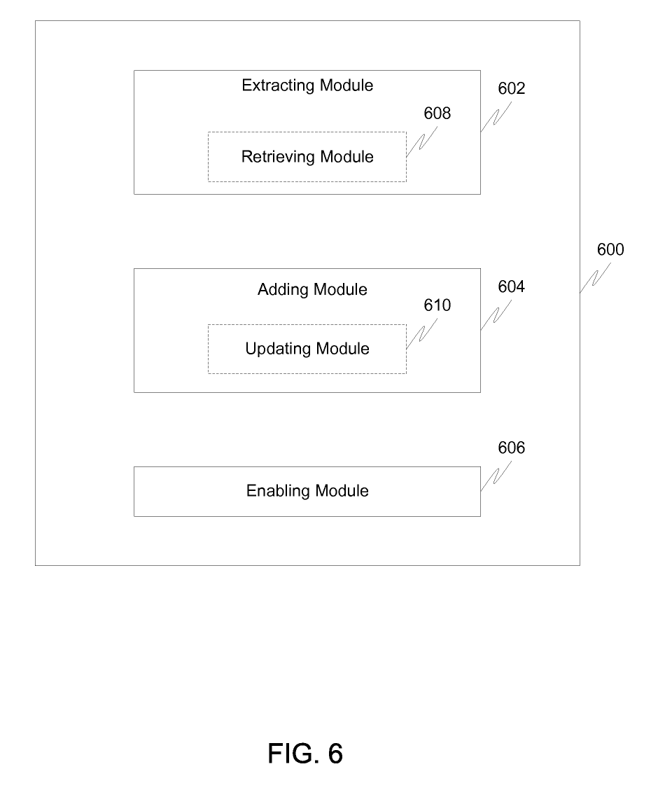

FIG. 6 is a block diagram showing a system 600 for creating a social network in a telecommunication network in accordance with an embodiment of the invention. The system 600 includes an extracting module 602, an adding module 604 and an enabling module 606.

A user of the telecommunication device 106-2 accesses the one or more services provided by the service provider 102 in the telecommunication network 104. In an embodiment of the invention, the one or more services provided by the service provider 102 may include a social networking service. In another embodiment of the invention a third party service provider may provide the social networking service to the user using the telecommunication network 104. The user of the telecommunication device 106-2 may subscribe to the social networking service provided by the service provider 102. In an embodiment of the invention, the user of the telecommunication device 106-2 may subscribe to the social networking service provided by the third party service provider. Using the social networking service, the user may create a social network corresponding to the user in the telecommunication network 104. In order to create the social network corresponding to the user, the extracting module 602 extracts one or more contact information corresponding to one or more users stored in the telecommunication device 106-2 of the user.

In an embodiment of the invention, the extracting module 602 includes a retrieving module 608. The retrieving module 608 extracts one or more contact information stored in one or more telecommunication device belonging to the one or more contact information stored in the telecommunication device 106-2 of the user and so on.

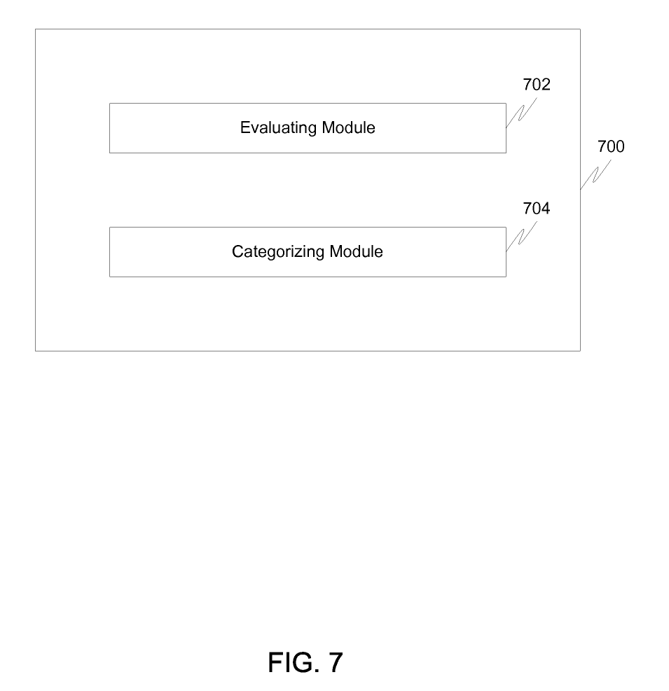

In response to extracting the one or more contact information, the adding module 604 adds the one or more contact information to the social network of the user. The contact information may include but is not limited to a name, a contact number and an email address corresponding to the one or more users stored in a phone book of the telecommunication device 106-2 of the user. In an exemplary embodiment of the invention, the one or more contact information in the social network of the user is organized. The system for organizing the one or more contact information in the social network has been explained in detail in conjunction with FIG. 7.

In an embodiment of the invention the adding module 604 includes an updating module 610. The updating module 610 updates the one or more contact information in the social network of the user from other sources including but not limiting to internet and an email client corresponding to the user.

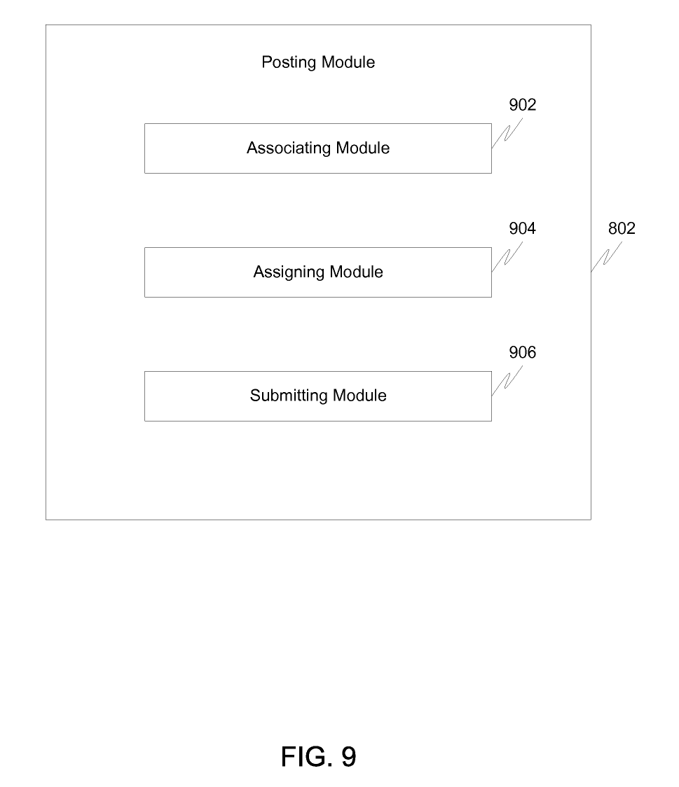

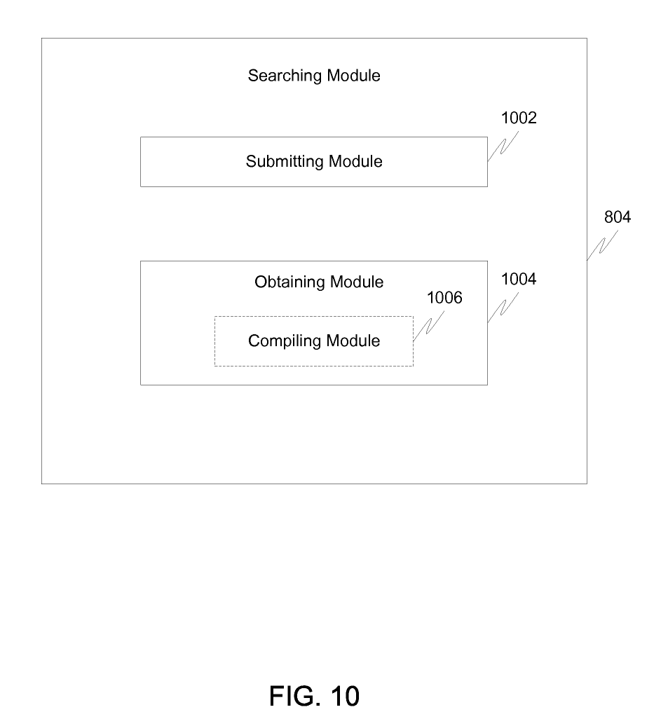

The enabling module 606 enables the user to perform a set of operations in the social network using the telecommunication device 106-2 of the user. The set of operations includes for example but are not limited to posting, searching, deleting and rating a review corresponding to an object in the social network of the user. The systems for posting the review and searching the review in the social network have been explained in detail in conjunction with FIG. 9 and FIG. 10 respectively.

FIG. 7 is a block diagram showing a system 700 for organizing one or more contact information in a social network in a telecommunication network in accordance with an embodiment of the invention. The system 700 includes an evaluating module 702 and a categorizing module 704. After the one or more contact information is added by the adding module 604 to the social network of the user as explained in FIG. 6, the one or more contact information is organized for better management of the social network The evaluating module 702 evaluates the one or more contact information in the social network of the user based on a set of parameters. The set of predefined parameters may include for example, but is not limited to, a degree of separation between the user and the one or more users and a predefined preference of the user. The predefined preference of the user may include for example, but is not limited to, grouping the one or more users into one or more groups like friend, colleague, business, married, bachelor and family member. In response to evaluating the one or more contact information, the categorizing module 704, categorizes the one or more contact information in different levels or in a hierarchy. The one or more contact information in the social network of the user may be categorized into a first level, a second level, a third level and so on. In an exemplary embodiment of the invention, the one or more contact information corresponding to the one or more users stored in the telecommunication device 106-2 of the user is categorized in a first level. The one or more contact information categorized in the first level is further categorized into a married group and a bachelor group based on a preference of the user. Other contact information corresponding to other users stored in a telecommunication device of a user corresponding to a first level contact information is categorized in a second level. It would be apparent to a person skilled in the art that the contact information can be categorized in a third level, a fourth level and so on based on the set of predefined parameters.

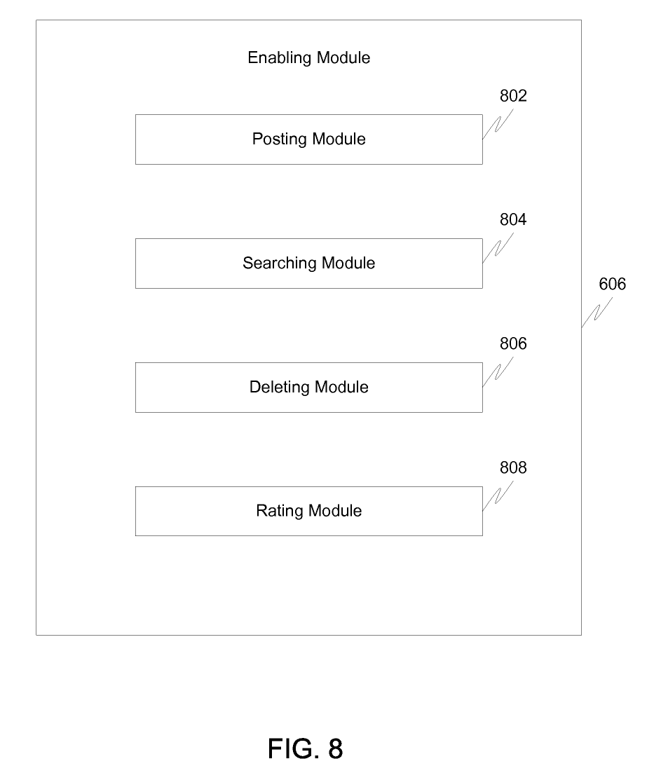

FIG. 8 is a block diagram showing the enabling module 606, for enabling the user to perform a set of operations using the telecommunication device 106-2 of the user in the social network of the user in accordance with an embodiment of the invention. The enabling module 606 includes a posting module 802, a searching module 804, a deleting module 806 and a rating module 808. The enabling module 606 enables the user to perform the set of operations in the social network using the telecommunication device 106-2 of the user. The set of operations includes for example, but is not limited to, posting, searching, deleting and rating the review corresponding to the object in the social network of the user. The posting module 802 enables the user to post the review corresponding to the object in the social network by using the telecommunication device 106-2 of the user. In an exemplary embodiment of the invention, the posting module 802 enables the user to use one or more of a SMS or a MMS for posting a review corresponding to an object in the social network of the user. The posting module 802 has been explained in detail in conjunction with FIG. 9.

The searching module 804 enables the user to search the review corresponding to the object in the social network by using the telecommunication device 106-2 of the user. The searching module 804 has been explained in detail in conjunction with FIG. 10. The deleting module 806 enables the user to delete the review corresponding to the object in the social network by using the telecommunication device 106-2 of the user. The rating module 808 enables the user to rate the review corresponding to the object in the social network by using the telecommunication device 106-2 of the user. In an exemplary embodiment, the user may rate a review corresponding to an object as five on a scale of one to ten in a social network of the user.

FIG. 9 is a block diagram showing the posting module 802 for posting a review corresponding to an object in the social network of the user in accordance with an embodiment of the invention. The posting module 802 includes an associating module 902, an assigning module 904 and a submitting module 906. The associating module 902 enables the user to associate a tag corresponding to the object with the review corresponding to the object by using the telecommunication device 106-2 of the user. The tag can be for example, but is not limited to, a photo, a video, an audio clip, a text, a user comment, a location information and a barcode corresponding to the object. The tag is obtained by using various features of the telecommunication device 106-2 of the user. The tag can be obtained, for example, from one or more of, but not limited to, a multimedia feature, an RFID detector and a barcode reader of the telecommunication device 106-2. In an exemplary embodiment of the invention the user can scan a barcode corresponding to an object using a multimedia barcode reader in the telecommunication device 106-2 of the user. The associating module 902 then associates the barcode with the review corresponding to the object to be used as a tag for the object.

In an embodiment of the invention, the tag may be one or more information corresponding to the object obtained from a third party source. In an exemplary embodiment of the invention, the user can scan a barcode corresponding to an object using a multimedia barcode reader in the telecommunication device 106-2 of the user. Also, a price corresponding to the object is obtained from the third party source. Thereafter, the associating module 902 associates the photo and the price with the review corresponding to the object to be used as a tag for the object.

The assigning module 904 enables the user to assign a privacy setting to the review corresponding to the object in the social network. The privacy setting may include, for example, but is not limited to, a visibility setting and an accessibility setting corresponding to the review of the object. In an exemplary embodiment of the invention, the assigning module 904 enables the user to configure the visibility setting corresponding to the review of the object posted by the user. As a result of the visibility setting, the other users corresponding to the other contact information categorized in a third level in the social network of the user cannot view the review corresponding to the object. In another exemplary embodiment of the invention, the assigning module 904 enables the user to configure an anonymous setting to the review corresponding to the object posted by the user. As a result of the anonymous setting, other users corresponding to other contact information categorized in a second level in the social network of the user cannot view the user's information. Further, in yet another exemplary embodiment of the invention, the assigning module 904 enables the user to configure the accessibility setting corresponding to the review such that only a few specified other users can have an access to the review posted by the user in the social network.

The submitting module 906 enables the user to submit the review corresponding to the object in the social network of the user by using the telecommunication device 106-2 of the user. In an exemplary embodiment of the invention, the submitting module 906 enables the user to use one or more of a SMS or a MMS for submitting the review in the social network.

FIG. 10 is a block diagram showing the searching module 804 for searching a review corresponding to an object in the social network of the user in accordance with an embodiment of the invention. The searching module 804 includes a submitting module 1002 and an obtaining module 1004. The submitting module 1002 enables the user to submit a query corresponding to the object in the social network using the telecommunication device 106-2 of the user. The user includes a tag corresponding to the object in the query. The tag can be for example, but is not limited to, a photo, a video, an audio clip, a text, a user comment, a location information and a barcode corresponding to the object. The tag is obtained by using various features of the telecommunication device 106-2 of the user. The tag can be obtained, for example, from one or more of, but not limited to, a multimedia feature, a RFID detector and a barcode reader of the telecommunication device 106-2. In an exemplary embodiment of the invention, the user may scan an object RFID-tag by using an RFID detector of the telecommunication device 106-2. The user may then include the scanned object RFID-tag in a query corresponding to the object using the telecommunication device 106-2 of the user.

In another embodiment of the invention, the tag may be one or more information corresponding to the object obtained from a third party source. In an exemplary embodiment of the invention, the user may scan an object RFID-tag by using an RFID detector of the telecommunication device 106-2. The user may also obtain a photo corresponding to the object from the third party source. The user may then use the scanned RFID-tag and the photo as a tag and include them in a query corresponding to the object using the telecommunication device 106-2 of the user.

In response to submitting the query the obtaining module 1004 enables the user to obtain one or more results corresponding to the object. The results may include for example, but are not limited to, one or more reviews, one or more recommendations and a ranking corresponding to the object.

In an embodiment of the invention, the obtaining module 1004 includes a compiling module 1006. The compiling module 1006 enables compiling the one or more results based on a privacy setting and an accessibility setting associated with the one or more results. In an embodiment of the invention, the compiling module 1006 compiles the one or more results based on a privacy setting and an accessibility setting associated with the one or more results. Based on the privacy setting and the accessibility setting a result is obtained and presented to the user. In an exemplary embodiment of the invention a result may be presented to the user as posted by an anonymous user after the compiling module 1006 compiles the result based on a privacy setting configured by the anonymous user.

Various embodiments of the invention provide methods and systems for creating a social network in a telecommunication network. The invention provides a method for creating the social network in the telecommunication network without any user authentication process. The invention provides a method to create the social network in the telecommunication network whereby the members of the social network are trusted members. The invention provides a method to create a social network in the telecommunication network by using the telecommunication device of the user without using any other computing device. The invention also provides a method and system to create a social network in the telecommunication network of the user which provides a greater degree of personalization to the user. The invention further provides a method and system to create a social network in the telecommunication network of the user which provides greater degree of usability by providing implicit context based on the members of the social network. The invention also provides a method and system to create a social network in the telecommunication network which enables easy access to the social network by using the telecommunication device of the user.

Those skilled in the art will realize that the above recognized advantages and other advantages described herein are merely exemplary and are not meant to be a complete rendering of all of the advantages of the various embodiments of the present invention.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims including any amendments made during the pendency of this application and all equivalents of those claims as issued.

What is claimed is:

1. A method of creating a social network in a telecommunication network, the method comprising:
extracting at least one contact information stored in a telecommunication device of a user, wherein the at the least one contact information corresponds to at least one user;
adding the at least one contact information to the social network of the user in response of extracting the contact information stored in the telecommunication device; and
enabling the user to perform a set of operations using the telecommunication device in the social network.

2. The method of claim 1, wherein the at least one contact information stored in the telecommunication device of the user comprises at least one of a name, a contact number and an email address corresponding to a user of the at least one user.

3. The method of claim 1, wherein extracting further comprises:
retrieving at least one contact information stored in at least one telecommunication device of the at least one user corresponding to the at least one contact information stored in the telecommunication device of the user.

4. The method of claim 1, wherein adding further comprises:
updating at least one contact information to the social network using at least one of a internet and email client.

5. The method of claim 1 further comprising:
evaluating the at least one contact information in the social network based on a set of predefined parameters; and
categorizing the at least one contact information in at least one level in response to evaluating the at least one contact information.

6. The method of claim 5, wherein the set of predefined parameters comprises at least one of a degree of separation between the user and the at least one contact information and a predefined preference of the user.

7. The method of claim 1, wherein the set of operations comprises at least one of:
posting a review corresponding to an object in the social network;
searching a review corresponding to an object in the social network;
deleting a review corresponding to an object in the social network; and
rating a review corresponding to an object in the social network.

8. The method of claim 7, wherein posting the review comprises:
associating a tag with the review corresponding to the object using the telecommunication device of the user;
assigning a privacy setting to the review corresponding to the object; and
submitting the review corresponding to the object in the social network.

9. The method of claim 8, wherein the tag comprises at least one of a photo, a video, an audio, user comment, a location information and a barcode corresponding to the object.

10. The method of claim 8, wherein the privacy setting comprises at least one of:
visibility setting corresponding to an identity of the user to the at least one user in the social network; and
accessibility setting corresponding to the review of the object in the social network.

11. The method of claim 7, wherein searching the review comprises:
submitting a query corresponding to the object using the telecommunication device of the user; and
obtaining a result set in response to submitting the query, wherein the result set comprises at least one review corresponding to the object in the social network.

12. The method of claim 11, wherein obtaining comprises:
compiling the result set based on a privacy setting associated with the at least one review corresponding to the object in the social network.

13. A system for creating a social network in a telecommunication network, the system comprising:
an extracting module for extracting at least one contact information stored in a telecommunication device of a user, wherein the at the least one contact information corresponds to at least one user;
an adding module for adding at least one contact information to the social network of the user in response of extracting the contact information stored in the telecommunication device; and
an enabling module for enabling the user to perform a set of operations using the telecommunication device in the social network.

14. The system of claim 13, wherein the extracting module further comprises:
a retrieving module for retrieving at least one contact information stored in at least one telecommunication device of the at least one user corresponding to the at least one contact information stored in the telecommunication device of the user.

15. The system of claim 13, wherein the adding module further comprises:
an updating module for updating at least one contact information to the social network using at least one of a internet and email client.

16. The system of claim 13 further comprises:
an evaluating module for evaluating the at least one contact information added to the social network based on a set of predefined parameters; and
a categorizing module for categorizing the at least one contact information in at least one level in response to evaluating the at least one contact information.

17. The system of claim 13, wherein the enabling module comprises at least one of:
a posting module for posting a review corresponding to an object in the social network;
a searching module for searching a review corresponding to an object in the social network;
a deleting module for deleting a review corresponding to an object in the social network; and
a rating module for rating a review corresponding to an object in the social network.

18. The system of claim 17, wherein the posting module further comprises:
an associating module for associating a tag with the review corresponding to the object using the telecommunication device of the user;
an assigning module for assigning a privacy setting to the review corresponding to the object; and
a submitting module for submitting the review corresponding to the object in the social network.

19. The system of claim 17, wherein the searching module further comprises:
a submitting module for submitting a query corresponding to the object using the telecommunication device of the user; and
an obtaining module for obtaining a result set in response to submitting the query, wherein the result set comprises at least one review corresponding to the object in the social network.

20. The system of claim 19, wherein the obtaining module further comprises:
a compiling module for compiling the result set based on a privacy setting associated with the at least one review corresponding to the object in the social network.
